(19) United States
(12) Patent Application Publication
(10) Pub. No.: US 2014/0373137 A1
(43) Pub. Date: Dec. 18, 2014

(54) MODIFICATION OF APPLICATION STORE OUTPUT

(71) Applicant: McAfee Inc., Santa Clara, CA (US)

(72) Inventor: Igor Muttik, Herts (GB)

(21) Appl. No.: 13/977,371

(22) PCT Filed: Mar. 5, 2013
(86) PCT No.: PCT/US13/29110

§ 371 Date: Jun. 28, 2013

(51) Int. Cl. H04L 29/06; G06F 21/57

(52) U.S. Cl. CPC H04L 63/0227; G06F 21/57
USPC 726/22

(57) ABSTRACT

Technologies for electronic communication may include receiving a group of indications. Each indication of an element of digital content may be configured to be downloaded to a client from a digital distribution framework. The technologies may also include evaluating each of the elements of digital content and, based on the evaluations, suppressing a display of one or more of the indications on the client.

### TECHNICAL FIELD OF THE INVENTION

Embodiments of the present invention relates generally to computer security and, more particularly, to modification of application store output.

### BACKGROUND

Malware infections on computers and other electronic devices are very intrusive and hard to detect and repair. Anti-malware solutions may require matching a signature of malicious code or files against evaluated software to determine that the software is harmful to a computing system. Malware may disguise itself through the use of polymorphic programs or executables wherein malware changes itself to avoid detection by anti-malware solutions. In such case, anti-malware solutions may fail to detect new or morphed malware in a zero-day attack. Malware may include, but is not limited to, spyware, rootkits, password stealers, spam, sources of phishing attacks, sources of denial-of-service-attacks, viruses, loggers, Trojans, adware, or any other digital content that produces unwanted activity.

### BRIEF DESCRIPTION OF THE DRAWINGS

For a more complete understanding of embodiments of the present invention and its features and advantages, reference is now made to the following description, taken in conjunction with the accompanying drawings, in which:

FIG. 1 is an illustration of an example embodiment of a system for modification of application store output;

FIG. 2 illustrates example additional configuration and operation of a system for modification of application store output;

FIG. 3 is an illustration of an example embodiment of a method for modification of application store output.

### DETAILED DESCRIPTION

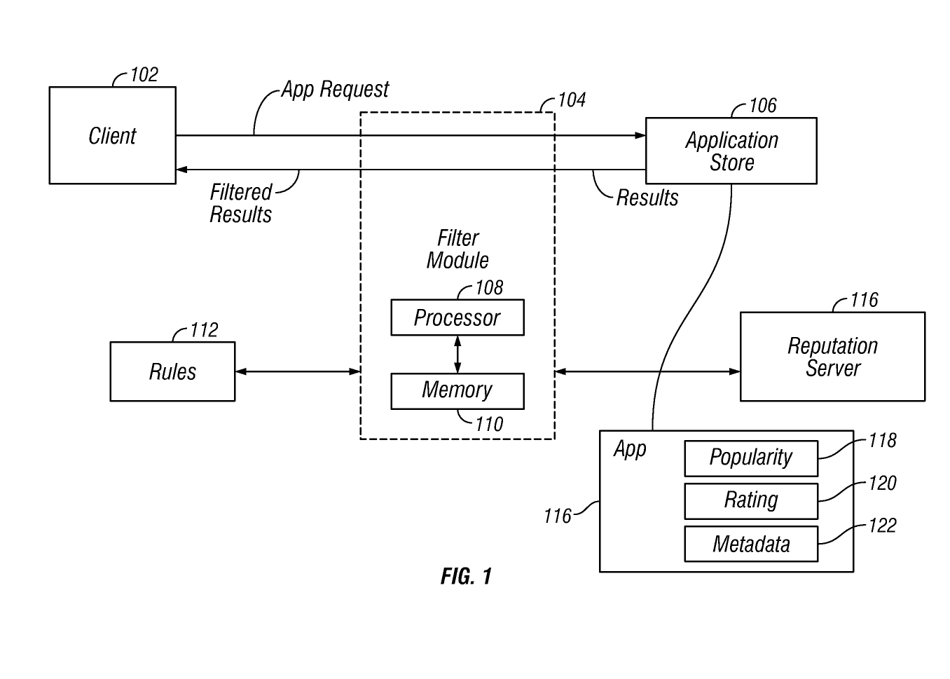

FIG. 1 is an illustration an illustration of an example embodiment of a system 100 for modification of application store output. Such modification may be performed, for example, for security purposes. Modifications may be performed upon content that has indications of malware, or that is unknown as to malware status and thus may represent a zero-day attack.

System 100 may include a filter module 104 communicatively coupled to a client 102. Client 102 may be communicatively coupled to an application store 106. Client 102 may be configured to contact application store 106 to determine one or more sources of content that may be remotely accessed, launched, or downloaded for use on client 102. Furthermore, client 102 may be configured to make a request for specific content such as an application. Application store 106 may be configured to generate a list or other indication of such content and send the results to client 102. Filter module 104 may be configured to filter the output of application store 106 such that undesirable results are not displayed on client 102. Filter module 104 may be configured to send the filtered results to client 102. In one embodiment, filter module 104 may be configured to modify the actual results as sent from application store 106 so that the results not passed in the filtered results do not arrive at client 192. In another embodiment, filter module 104 may be configured to modify the presentation of results within client 102 such that only filtered or partial results are displayed to users of client 102.

Client 102 may include any suitable entity that may attempt to access application store 106. For example, client 102 may be resident on any suitable electronic device such as a mobile device, computer, server, laptop, desktop, board, or blade. Furthermore, client 102 may attempt to access application store through, for example, an application, engine, utility, function, library, shared library, script, instructions, logic, or other suitable entity of client 102. Client 102 and application store 106 may be communicatively coupled over any suitable network connection such as the Internet, an intranet, a wide-area-network, a local-area-network, or a wireless network, using any suitable network protocol. Client 102 may be configured to make searches, browsing requests, or other attempted access of application store 106 for available content. Client 102 may display available content from application store 106 in any suitable manner, such as with a list, pictograms of each content, or an array of icons. Such display may enable a user of client 102 to select content for download to client 102 or another suitable destination.

Application store 106 may be implemented in any suitable manner. For example, application store 106 may include a digital distribution framework or platform. Application store 106 may be implemented on one or more electronic devices, such as servers, cloud computing schemes, computers, boards, or blades. Furthermore, application store 106 may be implemented with, for example, a program, application, engine, function, library, shared library, script, instructions, logic, or any suitable combination thereof. Application store 106 may include interfaces for accepting connections from any suitable kind of client, such as client 102. Application store 106 may be proprietary and dedicate to providing content associated with certain platforms, such as those on client 102, or may be open-ended and provide content across multiple platforms for use on various clients. Application store 106 may be accessible through a dedicated application, script, instructions, logic, module, or other entity on a client, or through an open-ended or general-purpose application such as a web browser. Application store 106 may include e-commerce facilities for recording and tracking downloads of content, whether such downloads are free or require remuneration. Application store 106 may be configured to respond to searches, browsing requests, or other suitable contacts for content. In response to requests, application store 106 may be configured to generate a list, indication of content, search results, or individual and one-by-one responses.

Application store 106 may be configured to provide any suitable digital content, such as media, applications, in-application features, add-ons, updates, patches, music, games, or video. In one embodiment, each piece of content may be stand-alone, self-contained, or otherwise presented on its own for selection and download. An individual piece of content within application store 106, such as entry 116, may include or be associated with a suitable array of entry. For example, each entry 116 within application store 106 may be associated with one or more ratings 120. Such ratings 120 may include feedback provided by users of application store 106, or ratings pulled from other locations. Ratings 120 may include a quantification of the number of individual indications of feedback submitted, reflecting the number of individual submissions of feedback or ratings, for a given entry. Furthermore, ratings 120 may include a quantification of the rating, reflecting an overall score for the entry 116 based on the received feedback or ratings. Any suitable quantification, such as a rating from zero to five, may be made for a piece of content. Entry 116 may include a popularity 118, which may include a quantification of the number of times entry 116 has been downloaded, installed, or otherwise accessed. Entry 116 may also include metadata 122, which may include information such as a unique identification of entry 116, version number, author, publisher, date released, date last updated, digital signature, or digital certificate. In addition, ratings 120 or metadata 122 may include an evaluation, date, or other information about a publisher, author, or other source of a given piece of content. Ratings 120 for the source of the content may be based on, for example, an aggregate rating of content associated with the source, ratings specifically made about the source, length of time the source has been authorized to provide or has provided content, or whether the source has been verified. Also, ratings 120 may include a temporal aspect, such that evaluations within a given time window or period may be considered when providing the ratings.

Furthermore, ratings, evaluations, reputations, or other analysis of content of application store 106 may be available outside of application store 106 in, for example, rules 112 or reputation server 114. Such analysis may include the ratings 120, popularity 118, or metadata 122 as described above as within entry 116. The analysis may be based on unique identification of the content, such as name, network location, filename, or a digital signature or hash. The identification of the content may be used to determine whether, for example, the content is associated with malware based on signatures of known malware; whether the content is known to include undesirable behavior, such as adware, pop-up ads, application crashes, phishing, expensive add-ons, misuse of private or personal information, or misuse of social media; whether an author, publisher, or other entity of the content is known, trusted, or malicious; whether the content is unknown as to malicious status; whether the content has compatibility problems with client 102; whether the content has known vulnerabilities, which may be specific to client 102; or whether the content may cause excessive resource consumption, such as drawing too much batter power of mobile or laptop devices, or significant or unnecessary network, processor, or memory usage.

Information about content in application store 106 and associated rating information may be stored in any suitable manner. For example, such information may be provided in response to queries for application listings in a format discoverable by or preconfigured for entities such as client 102 and filter module 104. Such formats may include, for example, extensible markup language (XML). In another example, such information may be defined according to a standard. In yet another example, such information may be reverse engineered from application store content or content listings to be determined.

Filter module 110 may be configured to determine when a request has been made from client 102 of application store 106. Such a request may be for a search or listing of available content on application store 106. The content may be in the form of, for example, entry 116. In another embodiment, filter module 110 may be configured to determine an attempted delivery of such search results or listing of available content on application store 106. Filter module 110 may be configured to perform such determinations in any suitable manner, such as through callback function registration within client 102, function wrappers, interposing functions within client 102, packet-sniffing, or reading network headers.

In one embodiment, application store 106 may include a secured connection with client 102. In another embodiment, application store 106 may be implemented as a closed system such that its structure of communications is closed and not known. In such embodiments, application store 106 may cooperate with client 102 to determine entries 116 that are returned from application store 106.

Filter module 102 may be configured to analyze each entry 116 received as a result of client 102 and application store 106 interacting to provide a list of available content to client 102. Furthermore, filter module 102 may be configured to analyze information within entry 116 such as popularity 118, rating 120, or metadata 122. In addition, filter module 102 may be configured to analyze information about entry 116 by accessing rules 112 or reputation server 114.

Based on the information about entry 116 in rules 112 or reputation server 114, filter module 102 may suppress entry 116 in client 102. Such suppression may be based upon undesirable or unknown aspects of entry 116 that may be determined or inferred from, for example, entry 116, rules 112, or reputation server 114. In one embodiment, suppression of entry 116 may be performed by removing the information about entry 116 as entry 116 is returned to client 102 from application store 106. In another embodiment, suppression of entry 116 may be performed by causing client 102 to not display entry 116 to a user of client 102. The suppression employed by filter module 104 may be selective. For example, given a restricted user, such as a child logged in to client 102, or a restricted client 102 itself, entry 116 may be suppressed given undesirable or unknown aspects of entry 116. However, given a, for example, supervisor or administrator, logged in to client 102, or an unrestricted client 102, entry 116 may be not suppressed even though it includes undesirable or unknown aspects. Furthermore, the suppression employed by filter module 104 may be variable according to the severity of undesirable or unknown aspects of entry 116. For example, if the undesirable or unknown aspects of entry 116 exceed a first threshold, entry 116 may be suppressed from restricted users but may be available to unrestricted users; however, if the undesirable or unknown aspects of entry 116 exceed a second, higher threshold, entry 116 may be suppressed from all users.

Rules 112 may include any suitable information for evaluating a given entry 116 reflecting content available on application store 106. Such information may include information specific to a given entry 116. For example, rules 112 may include blacklists, whitelists, anti-malware signature databases, anti-malware engines, ratings, scores, or other suitable information. For the identified entry 116, rules 112 provided information about the desirability, undesirability, or unknown nature of entry 116. Such information may include or be in addition to popularity 118, rating 120, or metadata 122. In one embodiment, such information may be different from that information stored by application store 106; rules 112 may be maintained by a party other than the party maintaining application store 106. Multiple rule sets from difference sources may be used, accessed separately, or combined. As such, the information of rules 112 may be independent of application store 106. Rules 112 may include information from third party reviews and sources of feedback. Further, rules 112 may include information as provided by researchers as it is discovered about entry 116. In one embodiment, rules 112 may be resident on filter module 104 or upon an electronic device upon which filter module 104 resides. In another embodiment, rules 112 may be resident on another electronic device communicatively coupled to filter module 104.

Reputation server 114 may also include information specific to a given entry 116, including blacklists, whitelists, anti-malware signature databases, ratings, scores or other suitable information, similar to rules 112 as described above. Such information may be mined from a variety of clients or data sources. Reputation server 114 may be communicatively coupled to filter module 104. Reputation server may be implemented by, for example, any suitable application, engine, utility, function, library, shared library, script, instructions, logic or other suitable entity operating on an electronic device such as a server, computer, blade, cloud computing scheme, or board.

Furthermore, rules 112 may include logic, thresholds, heuristics, or other criteria by which, given information about a given entry 116, filter module 104 may handle entry 116. Any suitable logic may be included. Furthermore, specific logic may be determined experimentally and updated by, for example, reputation server 114. Filter module 104 may utilize rules 112 to determine whether, and to what degree, a given entry 116 may be suppressed in client 102. Rules 112 may provide logic to characterize the severity of unknown or undesirable aspects of entry 116.

In one embodiment, rules 112 may specify that entry 116 must include a rating 120—for the entry 116 itself, its source, or application store 106—above a certain level to be trusted. Below such threshold, rules 112 may indicate to filter module 104 to suppress entry 116 from client 102. Rules 112 may include multiple such thresholds which may be selectively applied according to settings of client 102 or the identity of client 102.

In another embodiment, rules 112 may specify that entry 116 must include a popularity 118—for the entry 116 itself or for its source—above a certain level to be trusted. Below such threshold, rules 112 may indicate to filter module 104 to suppress entry 116 from client 102. Thus, for example, a new entry 116 which has not been downloaded many times may be suppressed until it has reached a critical level of prevalence, at which malicious behavior or properties are expected to be exposed. Rules 112 may include multiple such thresholds which may be selectively applied according to settings of client 102 or the identity of client 102.

In yet another embodiment, rules 112 may specify that entry 116 must be digitally signed by its source or author. Otherwise, rules 112 may indicate to filter module 104 to suppress entry 116 from client 102.

In still yet another embodiment, rules 112 may specify that entry 116 must not exhibit pop-up ads or include other designated types of in-use advertising. Otherwise, rules 112 may indicate to filter module 104 to suppress entry 116 from client 102.

In another embodiment, rules 112 may specify that entry 116 must not violate privacy restrictions. Such restrictions may include, for example, prohibitions on collecting user information, automatic access or linking to social media, or automatic registration for marketing. Otherwise, rules 112 may indicate to filter module 104 to suppress entry 116 from client 102.

In yet another embodiment, rules 112 may combine criteria from various methods such as those described above. For example, an entry 116 with less than a threshold number of downloads may be required to have a rating above a certain rating threshold; while an entry 116 with greater than the number of downloads may be required to have a rating above a second, lower rating threshold.

In such embodiments, an evaluation of the content in view of malware information may not yield a definitive determination. For example, an entry 116 may include malware, but may not be recognized as such and thus malware scanning of entry 116 may not yield a determination that entry 116 is definitively malware. Furthermore, whitelists may not show that entry 116 is definitively safe.

By preventing the display of content with low ratings, system 100 may thus prevent users of client 102 from downloading content that is harmful to client 102. Furthermore, by preventing the display of content with few downloads, system 100 may thus prevent users of client 102 from downloading malware that includes zero-day or targeted attacks. Such few downloads may reflect that few opportunities have existed for users to download the content, observe the malware, and report it with, for example, a rating or an alert to anti-malware researchers or vendors. Furthermore, by preventing the display of content with undesirable behavior or properties, system 100 may thus prevent users of client 102 from downloading content that is harmful to users of client 102.

Filter module 104 may be resident within a client that it is securing, such as client 102, in various embodiments. In various other embodiments, filter module 104 may be resident on another electronic device. In any such embodiment, filter module 104 may be resident upon an electronic device such as a network appliance, mobile device, router, computer, server, laptop, desktop, board, firewall or blade. Filter module 104 may be resident upon an electronic device including a processor 108 coupled to a memory 110. Filter module 104 may be implemented in any suitable manner, such as by an application, program, proxy, engine, utility, function, library, shared library, script, instructions, logic, digital or analog circuitry, or any suitable combination thereof.

Filter module 104 may be communicatively coupled to client 102. Furthermore, filter module 104 may be communicatively coupled to application store 106. In one embodiment, filter module 104 may be configured to receive transmissions to or from client 102 and application store 106, and to subsequently copy, resend, or forward such transmissions to the intended recipient. In another embodiment, filter module 104 may be configured as a passive listener on communications between client 102 and application store 106. Filter module 104 may be configured to maintain separate network connections to client 102 and application 106. Furthermore, filter module 104 may be configured to maintain a single network connection between client 102 and application 106.

Processor 108 may comprise, for example, a microprocessor, microcontroller, digital signal processor (DSP), application specific integrated circuit (ASIC), or any other digital or analog circuitry configured to interpret and/or execute program instructions and/or process data. In some embodiments, processor 108 may interpret and/or execute program instructions and/or process data stored in memory 110. Memory 110 may be configured in part or whole as application memory, system memory, or both. Memory 110 may include any system, device, or apparatus configured to hold and/or house one or more memory modules. Each memory module may include any system, device or apparatus configured to retain program instructions and/or data for a period of time (e.g., computer-readable storage media). Instructions, logic, or data for configuring the operation of system 100, such as configurations of components such as filter module 104, may reside in memory 110 for execution by processor 108.

Processor 108 may execute one or more code instruction(s) to be executed by the one or more cores of the processor. The processor cores may follow a program sequence of instructions indicated by the code instructions. Each code instruction may be processed by one or more decoders of the processor. The decoder may generate as its output a micro operation such as a fixed width micro operation in a predefined format, or may generate other instructions, microinstructions, or control signals which reflect the original code instruction. Processor 108 may also include register renaming logic and scheduling logic, which generally allocate resources and queue the operation corresponding to the convert instruction for execution. After completion of execution of the operations specified by the code instructions, back end logic within processor 108 may retire the instruction. In one embodiment, processor 108 may allow out of order execution but requires in order retirement of instructions. Retirement logic within processor 108 may take a variety of forms as known to those of skill in the art (e.g., re-order buffers or the like). The processor cores of processor 108 are thus transformed during execution of the code, at least in terms of the output generated by the decoder, the hardware registers and tables utilized by the register renaming logic, and any registers modified by the execution logic

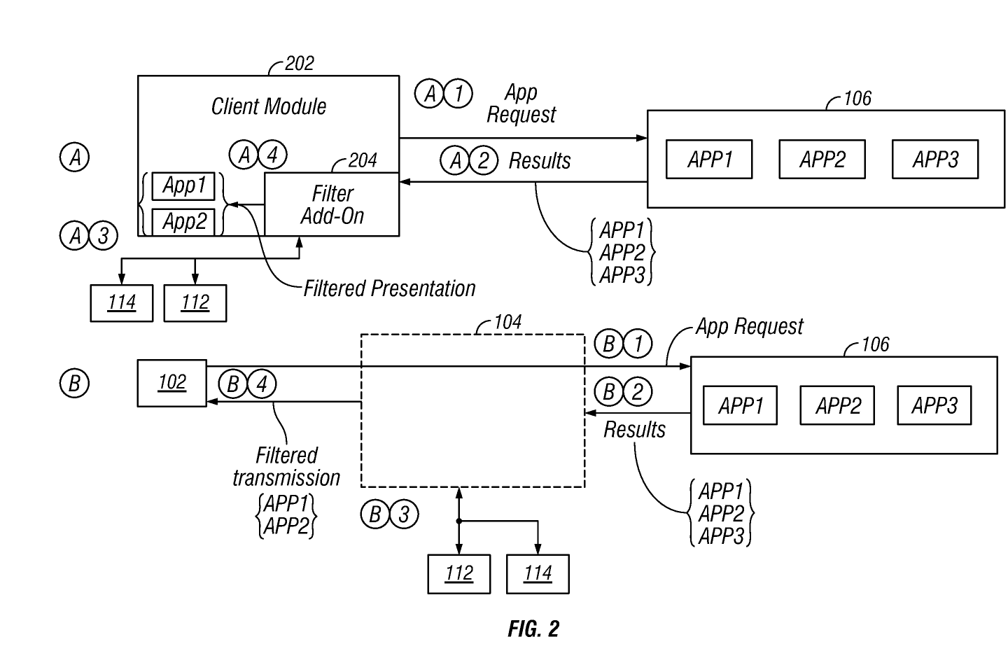

FIG. 2 illustrates example configuration and operation of system 100 for modifying an application store output. In (A), filter module 104 may be configured to provide modification of output of application store 106 from within client 102. In (B), filter module 104 may be configured to modify application store 106 output as it is transmitted to client 102. Such modification may include suppressing one or more entries 116 returned from application store 106.

In (A), filter module 104 may be implemented fully or in part by a filter add-on 204. Filter add-on 204 may include, for example, a function, library, plug-in, application extension, applet, logic, or instructions that perform some or all of the functions of filter module 104. Filter add-on 204 may be configured to cooperate with another application, such as client module 202. Client module 202 may include any suitable application, engine, utility, function, library, shared library, script, instructions, logic or other suitable entity operating on client 102. Client module 202 may include the entity which has requested content from application store 106, or is otherwise in communication with application store 106 to download content. In one embodiment, filter add-on 204 may be implemented within client module 202. In another embodiment, filter add-on 204 may be implemented outside of client module 202.

At (A)(1), client module 202 may request a listing, search of available content, or a specific piece of content from application store 106. Application store 106 may include a variety of content, such as App1, App2, and App3. Each of App1, App2, and App3 may be associated with an entry 116. At (A)(2), application store 106 may cause a transmission of a listing of content, including indications of App1, App2, and App3. Furthermore, the list may be retrieved one-by-one, according to the request of the client. At (A)(3), filter add-on 204 may analyze the received results. In one embodiment, the transmission from application store 106 may be intercepted by filter add-on 204. In another embodiment, filter add-on 204 may be invoked by client module 202 upon receipt of the results from application store 106. Filter add-on 204 may analyze the results by, for example, accessing rules 112 or reputation server 114. At (A)(4), filter add-on 204 may suppress the presentation of results received from application store 106. Filter add-on 204 may suppress the presentation by, for example, removing undesirable results from those received from application store 106, such that client module 202 only has such filtered results to present in a filtered presentation. In another example, filter add-on 204 may invoke a function or other mechanism of client module 202 to cause undesirable results to be shaded out, removed, or otherwise rendered inoperable within the presentation of results within client module 202. For example, given results App1, App2, and App3 from application store 106, App3 may have a rating below a threshold as defined by rules 112.

In (B), filter module 104 may be configured to modify application store 106 output as it is transmitted to client 102. Results from application store 106 may be selectively suppressed such that they are not received by client 102.

At (B)(1) client 102 may request a listing or a search of available content from application store 106. Application store 106 may include a variety of content, such as App1, App2, and App3. Each of App1, App2, and App3 may be associated with an entry 116. At (B)(2), application store 106 may cause a transmission of a listing of content, including indications of App1, App2, and App3. At (B)(3), filter module 104 may intercept and analyze the received results by, for example, accessing rules 112 or reputation server 114. At (B)(4), filter module 104 may suppress the presentation of results received from application store 106. Filter add-on 204 may suppress the presentation by, for example, removing undesirable results from those received from application store 106, such that client module 202 only has such filtered results to present in a filtered presentation. In another example, filter add-on 204 may invoke a function or other mechanism of client module 202 to cause undesirable results to be shaded out, removed, or otherwise rendered inoperable within the presentation of results within client module 202. For example, given results App1, App2, and App3 from application store 106, App3 may have a rating below a threshold as defined by rules 112.

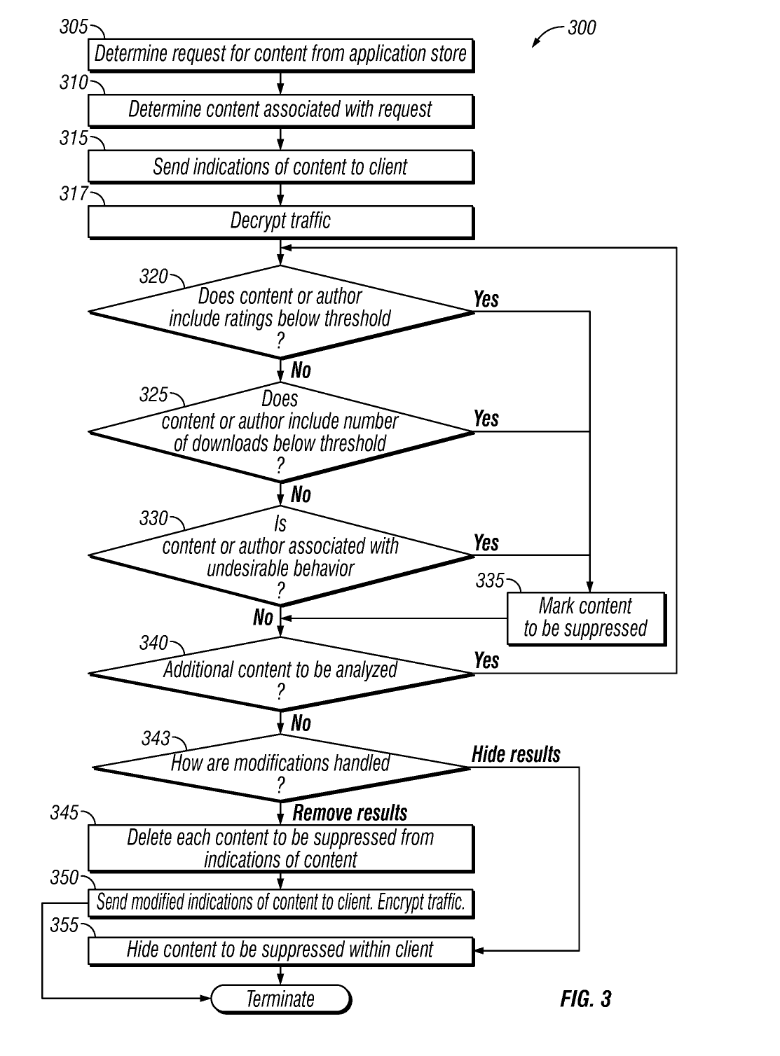

FIG. 3 is an illustration of an example embodiment of a method 300 for modification of application store output. Method 300 may be initiated by any suitable criteria. Furthermore, although method 300 describes a client and a server, method 300 may be performed by any network node recipient, network node sender, and monitor. Method 300 may be implemented using the system of FIGS. 1-2 or any other system operable to implement method 300. As such, the preferred initialization point for method 300 and the order of the elements comprising method 300 may depend on the implementation chosen. In some embodiments, some elements may be optionally omitted, repeated, or combined. In certain embodiments, method 300 may be implemented partially or fully in software embodied in computer-readable media.

In one embodiment, at 305, a request for content from an application store may be determined. Such a request may include, for example, a browsing request, a search, or any other indication to send indications of content from the application store to a client. The request may originate from a client. In another embodiment, an application store may be configured to operate in push mode, such that available content is to be automatically determined and sent to a client without a user of the client requesting such results. In such an embodiment, at 305, it may be determined that a push of content to a client is to be made. Such a determination may be made, for example, periodically, upon release of new content related to a registered client, upon a determination that the client has taken a particular action or operation, or upon determination that a given client is on-line.

At 310, content associated with the request may be determined. Any suitable number of pieces of content may be determined. Each piece of content may include any suitable kind and number of indications and information about the piece of content. For example, the piece of content may include a unique identifier, ratings about the content or the author of the content, number of times downloaded, identification of the author, or the number of content downloads associated with the author. At 315, the indications and information may be sent to the client. At 317, the transmission may be decrypted.

At 320-330, any suitable analysis upon the content or indications thereof may be conducted. Such analysis may be made, for example, upon interception of the information before reaching the client, or upon demand by the client after receiving the information. The analysis may be performed by, for example, consulting rules, anti-malware information, or a reputation database. Furthermore, different kinds of criteria of analysis may be combined with other kinds of criteria of analysis. Thus, 320-330 represent example tests that may be performed about the content.

At 320, it may be determined whether the content or the author thereof is associated with ratings that are below a threshold. If so, method 300 may proceed to 335. If not, method 300 may proceed to 325.

At 325, it may be determined whether the content or the author thereof is associated with a number of downloads that are below a threshold. If so, method 300 may proceed to 335. If not, method 300 may proceed to 330.

At 330, it may be determined whether the content or the author thereof is associated with undesirable behavior or properties. If so, method 300 may proceed to 335. If not, method 300 may proceed to 340.

At 335, it may be determined that, based on one or more rules, criteria, or heuristics, that the content should be suppressed from presentation to a user of the client. The content may be marked or denoted as such.

At 340, it may be determined whether additional content is to be analyzed. If so, method 300 may proceed to 320. If not, method 300 may proceed to 343.

At 343, any suitable corrective action may be taken to modify the output of the application store. The suitable corrective action may be determined. For example, if monitoring is occurring within the client and the additional content has already been received, it may be determined that identified results are to be hidden or obfuscated, and method 300 may proceed to 355. If monitoring is occurring at, for example, a proxy for the client, it may be determined that identified results are to be deleted from those sent to the client, and method 300 may proceed to 345.

At 345, each content to be suppressed may be deleted from indications of content. At 350, the modified content indications may be encrypted and may be sent to the client.

At 355, the content that is to be suppressed may be hidden, grayed out, or otherwise disabled within the content.

Method 300 may terminate or may optionally repeat.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such wires, optical fibers, and other electromagnetic and/or optical carriers; and/or any combination of the foregoing. The following examples pertain to further embodiments. Specifics in the examples may be used anywhere in one or more embodiments described above or herein.

The following examples pertain to further embodiments.

A method for electronic communication may be performed on an electronic device. Any suitable portions or aspects of the method may be implemented in at least one machine readable storage medium or in a system, as described below. The method may include any suitable combination of elements, actions, or features. For example, the method may include receiving a group of indications. Each indication of an element of digital content may be configured to be downloaded to a client from a digital distribution framework. The method may also include evaluating each of the elements of digital content and, based on the evaluations, suppressing a display of one or more of the indications on the client. Furthermore, suppressing the display may include removing the one or more indications from the group of indications and sending a modified group of indications to the client. In addition, suppressing the display may include obscuring the display of the one or more indications from within the client. Furthermore, evaluating each of the elements of digital content may include evaluating a user-based rating of the element of digital content. In addition, evaluating each of the elements of digital content may include evaluating a number of times the element of digital content has been downloaded. Furthermore, evaluating each of the elements of digital content may include evaluating a source of the element of digital content. In addition, evaluating each of the elements of digital content may include evaluating known behavior or properties about the element of digital content.

At least one machine readable storage medium may include computer-executable instructions carried on the computer readable medium. Various aspects of the medium may implement any suitable portions or combinations of the method described above or the system described below. The instructions may be readable by a processor. The instructions, when read and executed, may cause the processor to receive a group of indications. Each indication of an element of digital content may be configured to be downloaded to a client from a digital distribution framework. The instructions may also cause the processor to evaluate each of the elements of digital content and, based on the evaluations, suppressing a display of one or more of the indications on the client. Furthermore, suppressing the display may include removing the one or more indications from the group of indications and sending a modified group of indications to the client. In addition, suppressing the display may include obscuring the display of the one or more indications from within the client. Furthermore, evaluating each of the elements of digital content may include evaluating a user-based rating of the element of digital content. In addition, evaluating each of the elements of digital content includes evaluating a number of times the element of digital content has been downloaded. Furthermore, evaluating each of the elements of digital content may include evaluating a source of the element of digital content. In addition, evaluating each of the elements of digital content includes evaluating known behavior or properties about the element of digital content.

A system may be configured for electronic communication. The system may implement any suitable portions or combinations of the method or the at least one machine readable storage medium as described above. The system may include a processor coupled to a computer readable medium and computer-executable instructions carried on the computer readable medium. The instructions may be readable by a processor. The instructions, when read and executed, may cause the processor to receive a group of indications. Each indication of an element of digital content may be configured to be downloaded to a client from a digital distribution framework. The instructions may also cause the processor to evaluate each of the elements of digital content and, based on the evaluations, suppressing a display of one or more of the indications on the client. Furthermore, suppressing the display may include removing the one or more indications from the group of indications and sending a modified group of indications to the client. In addition, suppressing the display may include obscuring the display of the one or more indications from within the client. Furthermore, evaluating each of the elements of digital content may include evaluating a user-based rating of the element of digital content. In addition, evaluating each of the elements of digital content includes evaluating a number of times the element of digital content has been downloaded. Furthermore, evaluating each of the elements of digital content may include evaluating a source of the element of digital content. In addition, evaluating each of the elements of digital content includes evaluating known properties or behavior about the element of digital content.

Specifics in the examples above may be used anywhere in one or more embodiments.

Although the present disclosure has been described in detail, it should be understood that various changes, substitutions, and alterations can be made hereto without departing from the spirit and the scope of the disclosure as defined by the appended claims.

1-18. (canceled)

19. A method for electronic communications, comprising:
receiving a group of indications, each indication of an element of digital content configured to be downloaded to a client from a digital distribution framework;
evaluating each of the elements of digital content; and
based on the evaluations, suppressing a display of one or more of the indications on the client.

20. The method of claim 19, wherein suppressing the display includes:
removing the one or more indications from the group of indications;
sending a modified group of indications to the client.

21. The method of claim 19, wherein suppressing the display includes obscuring the display of the one or more indications from within the client.

22. The method of claim 19, wherein evaluating each of the elements of digital content includes evaluating a user-based rating of the element of digital content.

23. The method of claim 19, wherein evaluating each of the elements of digital content includes evaluating a number of times the element of digital content has been downloaded.

24. The method of claim 19, wherein evaluating each of the elements of digital content includes evaluating a source of the element of digital content.

25. The method of claim 19, wherein evaluating each of the elements of digital content includes evaluating known properties associated with the element of digital content.

26. At least one machine readable storage medium, comprising computer-executable instructions carried on the computer readable medium, the instructions readable by a processor, the instructions, when read and executed, for causing the processor to:
receive a group of indications, each indication of an element of digital content configured to be downloaded to a client from a digital distribution framework;
evaluate each of the elements of digital content; and
based on the evaluations, suppress a display of one or more of the indications on the client.

27. The medium of claim 26, wherein suppressing the display includes:
removing the one or more indications from the group of indications;
sending a modified group of indications to the client.

28. The medium of claim 26, wherein suppressing the display includes obscuring the display of the one or more indications from within the client.

29. The medium of claim 26, wherein evaluating each of the elements of digital content includes evaluating a user-based rating of the element of digital content.

30. The medium of claim 26, wherein evaluating each of the elements of digital content includes evaluating a number of times the element of digital content has been downloaded.

31. The medium of claim 26, wherein evaluating each of the elements of digital content includes evaluating a source of the element of digital content.

32. The medium of claim 26, wherein evaluating each of the elements of digital content includes evaluating known properties associated with the element of digital content.

33. A system for electronic communication, comprising:
a processor coupled to a computer readable medium; and
computer-executable instructions carried on the computer readable medium, the instructions readable by the processor, the instructions, when read and executed, for causing the processor to:
receive a group of indications, each indication of an element of digital content configured to be downloaded to a client from a digital distribution framework;
evaluate each of the elements of digital content; and
based on the evaluations, suppress a display of one or more of the indications on the client.

34. The system of claim 33, wherein suppressing the display includes:
removing the one or more indications from the group of indications;
sending a modified group of indications to the client.

35. The system of claim 33, wherein suppressing the display includes obscuring the display of the one or more indications from within the client.

36. The system of claim 33, wherein evaluating each of the elements of digital content includes evaluating a user-based rating of the element of digital content.

37. The system of claim 33, wherein evaluating each of the elements of digital content includes evaluating a number of times the element of digital content has been downloaded.

38. The system of claim 33, wherein evaluating each of the elements of digital content includes evaluating a source of the element of digital content.

39. The system of claim 33, wherein evaluating each of the elements of digital content includes evaluating known properties about the element of digital content.
